(19) United States
(12) Patent Application Publication
(10) Pub. No.: US 2023/0174734 A1
(43) Pub. Date: Jun. 8, 2023

(54) THERMALLY EXPANDABLE MICROSPHERES PREPARED FROM BIO-BASED MONOMERS

(71) Applicant: NOURYON CHEMICALS INTERNATIONAL B.V., Amsterdam (NL)

(72) Inventors: Anna LARSSON-KRON, Sundsvall (SE); Dariusz ZASADOWSKI, Sundsvall (SE)

(73) Assignee: NOURYON CHEMICALS INTERNATIONAL B.V., Amsterdam (NL)

(21) Appl. No.: 17/995,157

(22) PCT Filed: Apr. 1, 2021
(86) PCT No.: PCT/EP2021/058762

§ 371 Date: Sep. 30, 2022

(30) Foreign Application Priority Data
Apr. 3, 2020 (EP) 20168101.2

(51) Int. Cl. C08J 9/14; C08J 9/18; C08J 3/03

(52) U.S. Cl. CPC C08J 9/14; C08J 9/18; C08J 3/03; C08J 2343/00

(57) ABSTRACT

The present disclosure relates to thermoplastic polymeric microspheres comprising a thermoplastic polymer shell surrounding a hollow core, in which the thermoplastic polymer shell comprises a copolymer of a monomer of Formula 1:

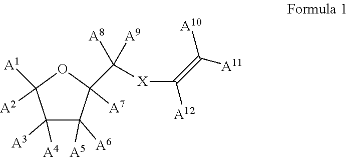

wherein:
each of A¹ to A¹¹ are independently selected from H and C₁ to C₄ alkyl, in which each C₁₋₄ alkyl group can optionally be substituted with one or more substituents selected from halogen, hydroxy and C₁₋₄ alkoxy;
A¹² is selected from C₁ to C₄ alkyl, in which the C₁₋₄ alkyl group can optionally be substituted with one or more substituents selected from halogen, hydroxy and C₁₋₄ alkoxy
X is a linking group selected from —O—, —NR″—, —S—, —OC(O)—, —NR″C(O)—, —SC(O)—, —C(O)O—, —C(O)NR″—, and —C(O)S—; and
   R″ is H or C₁₋₂ alkyl optionally substituted with one or more substituents selected from halogen and hydroxyl.

### CROSS-REFERENCE TO RELATED APPLICATION

This application is a U.S. National-Stage entry under 35 U.S.C. § 371 based on International Application No. PCT/EP2021/058762, filed Apr. 1, 2021, which was published under PCT Article 21(2) and which claims priority to European Application No. 20168101.2, filed Apr. 3, 2020, which are all hereby incorporated in their entirety by reference.

### TECHNICAL FIELD

The present disclosure relates to thermally expandable microspheres at least partially prepared from bio-based monomers and to a process of their manufacture. The present disclosure further provides expanded microspheres prepared from the thermally expandable microspheres.

### BACKGROUND

Thermally expandable microspheres are known in the art, and are described for example in U.S. Pat. No. 3,615,972, WO 00/37547 and WO2007/091960. A number of examples are sold under the trade name Expancel®. They can be expanded to form extremely low weight and low density fillers, and find use in applications such as foamed or low density resins, paints and coatings, cements, inks and crack fillers. Consumer products that often contain expandable microspheres include lightweight shoe soles (for example for running shoes), textured coverings such as wallpaper, solar reflective and insulating coatings, food packaging sealants, wine corks, artificial leather, foams for protective helmet liners, and automotive weather strips.

Thermally expandable polymer microspheres usually comprise a thermoplastic polymeric shell, with a hollow core comprising a blowing agent which expands on heating. Examples of blowing agents include low boiling hydrocarbons or halogenated hydrocarbons, which are liquid at room temperature, but which vaporise on heating. To produce expanded microspheres, the expandable microspheres are heated, such that the thermoplastic polymeric shell softens, and the blowing agent vaporises and expands, thus expanding the microsphere. Typically, the microsphere diameter can increase between about 1.5 and 8 times during expansion. Expandable microspheres are marketed in various forms, e.g. as dry free-flowing particles, as aqueous slurry or as a partially dewatered wet cake.

Expandable microspheres can be produced by polymerizing ethylenically unsaturated monomers in the presence of a blowing agent, for example using a suspension-polymerisation process. Typical monomers include those based on acrylates, acrylonitriles, acrylamides, vinylidene dichloride and styrenes. A problem associated with such thermoplastic polymers is that they are typically derived from petrochemicals, and are not derived from sustainable sources. However, it is not necessarily easy merely to replace the monomers with more sustainable-derived alternatives, since it is necessary to ensure that acceptable expansion performance is maintained. For example, the polymer must have the right surface energy to get a core-shell particle in a suspension polymerization reaction so that the blowing agent is encapsulated. In addition, the produced polymer must have good gas barrier properties to be able to retain the blowing agent. Further, the polymer must have suitable viscoelastic properties above glass transition temperature T_{g} so that the shell can be stretched out during expansion. Therefore, replacement of conventional monomers by bio-based monomers is not easy.

Expandable microspheres have been described, in which at least a portion of the monomers making up the thermoplastic shell are bio-based, being derivable from renewable sources.

WO2019/043235 describes polymers comprising lactone monomers with general formula:

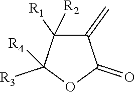

where R₁-R₄ are each independently selected from H and C₁₋₄ alkyl.

WO2019/101749 describes copolymers comprising itaconate dialkylester monomers of general formula:

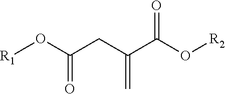

where each of R₁ and R₂ are separately selected from alkyl groups.

US2017/0081492 describes heat-expandable microspheres in which the polymeric component comprises a methacrylate monomer and a carboxyl-containing monomer. Amongst many examples of methacrylate monomers that are suggested as being suitable is tetrahydrofurfuryl methacrylate, although no examples of polymers containing this monomer are provided, nor any properties of any such polymers or polymeric microspheres.

There remains a need for alternative thermoplastic expandable microspheres in which the thermoplastic polymer shell is, at least in part, derived from sustainable sources.

### BRIEF SUMMARY

The present disclosure relates to thermoplastic polymeric microspheres comprising a thermoplastic polymer shell surrounding a hollow core, in which the thermoplastic polymer shell comprises a copolymer of a monomer of Formula 1:

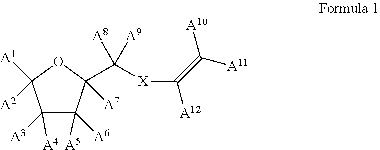

Each of A¹ to A¹¹ are independently selected from H and C₁ to C₄ alkyl, in which each C₁₋₄ alkyl group can optionally be substituted with one or more substituents selected from halogen, hydroxy and C₁₋₄ alkoxy. A₁₂ is selected from C₁₋₄ alkyl optionally substituted with one or more substituents selected from halogen, hydroxyl and C₁₋₄ alkoxy.

X is a linking group selected from —O—, —NR″—, —S—, —OC(O)—, —NR″C(O)—, —SC(O)—, —C(O)O—, —C(O)NR″—, and —C(O)S—. The group C(O) represents a carbonyl group, C═O. R″ is H or C₁₋₂ alkyl optionally substituted with one or more substituents selected from halogen and hydroxy.

The copolymer also comprises at least one monomer not of Formula 1, which has no more than one non-aromatic C═C double bond. At least one of these comonomers is a nitrile-based monomer. The content of nitrile-based monomer in the copolymer is greater than 20 wt %, based on the total weight of the polymer.

The present disclosure also relates to a process for preparing such thermoplastic polymeric microspheres, in which an organic phase comprising two or more monomers and one or more blowing agents is dispersed in a continuous aqueous phase, and polymerisation is initiated by a polymerisation initiator to form an aqueous dispersion of thermoplastic polymeric microspheres comprising a thermoplastic polymer shell surrounding a hollow core, the hollow core comprising the one or more blowing agents, wherein at least one monomer is a monomer of Formula 1 and at least one monomer is a nitrile-containing monomer in an amount of at least about 20 wt %, preferably about 30 wt.-% based on the total monomer content.

The present disclosure further relates to uses of the thermoplastic polymeric microspheres, e.g. as low density fillers and/or as foaming agents.

### BRIEF DESCRIPTION OF DRAWINGS

The present disclosure will hereinafter be described in conjunction with the following drawing figures, and:

FIGS. 1A and 1B are illustrations depicting single core and multiple core microspheres.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. It is to be appreciated that all numerical values as provided herein, save for the actual examples, are approximate values with endpoints or particular values intended to be read as “about” or “approximately” the value as recited.

In the discussion below, the term “(meth)acryl-” is often used. This is intended to encompass both the term “acryl-” and the term “methacryl-”. For example “(meth)acrylate” encompasses “acrylate” and “methacrylate”, and “(meth)acrylamide” encompasses “acrylamide” and “methacrylamide”.

The thermoplastic polymeric microspheres according to the present disclosure are produced from monomers which are at least partially bio-based. By bio-based it is meant that the monomers are at least partially derived from biologically-derived sustainable and renewable sources, typically from plants or microorganisms. Consequently, they can be used to help increase the proportion of the microspheres that are derived from sustainable raw materials, and reduce reliance on monomers derived from non-renewable mineral sources such as crude oil.

The thermoplastic polymeric microspheres have a hollow core encapsulated by the thermoplastic polymer shell, which can contain one or more blowing agents, and can be made to expand on heating, i.e. the microspheres can be expandable.

For microspheres to be expandable, the thermoplastic polymer shell must be sufficiently impermeable to the blowing agent(s) to prevent them leaking out before use, while at the same time having properties that allow the microspheres to expand and increase their volume on heating, resulting in expanded microspheres of lower density than the pre-expanded material.

It has been found that co-polymers comprising monomers of Formula 1 (which can be produced from sustainable raw materials) and one or more other ethylenically unsaturated co-monomers not of Formula 1 having no more than one non-aromatic C═C double bond, at least one of which is a nitrile-containing monomer, are able to produce thermally expandable microspheres with the required properties.

### Polymeric Shell

The thermoplastic polymer shell of the microspheres of the present disclosure is or comprises a copolymer (herein also referred to as polymer) of at least one monomer of Formula 1 and one or more other ethylenically unsaturated co-monomers not of Formula 1 having no more than one non-aromatic C═C double bond, at least one of which is a nitrile-containing monomer. In embodiments, the shell is or comprises a copolymer comprising more than one monomer of Formula 1. In embodiments, there can be two or more other ethylenically unsaturated co-monomers that are not of Formula 1, and which have a single non-aromatic C═C double bond, at least one of which is a nitrile-containing monomer.

In embodiments, the polymer is a copolymer of at least one monomer of Formula 1 and one or more other ethylenically unsaturated co-monomers not of Formula 1 having no more than one non-aromatic C═C double bond, at least one of which is a nitrile-containing monomer.

Copolymers can be based on 2 to 5 different comonomers, for example 2 to 3 comonomers, at least one of which is of Formula 1.

Suitable co-monomers not of Formula 1 include, for example (meth)acrylics) such as (meth)acrylic acid and (meth)acrylates; vinyl esters; styrenes (such as styrene and α-methylstyrene); nitrile-containing monomers (e.g. (meth)acrylonitrile); (meth)acrylamides; vinylidene halides (e.g. vinylidene halides, vinyl chloride and vinyl bromide); vinyl ethers (e.g. methyl vinyl ether and ethyl vinyl ether); maleimide and N-substituted maleimides; dienes (e.g. butadiene and isoprene); vinyl pyridine; itaconate dialkyl esters; lactones; and any combination thereof, provided at least one comonomer not of Formula 1 is a nitrile-containing monomer.

In embodiments, comonomers not of Formula 1 are selected from (meth)acrylonitrile, methyl (meth)acrylate, vinylidene dichloride, methacrylic acid, methacrylamide, itaconate dialkyl esters or any combination thereof, provided at least one comonomer not of Formula 1 is a nitrile-containing monomer.

By “(meth)acrylic monomers” it is meant a compound and isomers thereof according to the general formula:

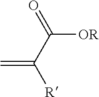

wherein R can be selected hydrogen and an alkyl containing from about 1 to 20 (e.g. about 1 to 12) carbon atoms and R′ can be selected from hydrogen and methyl. R can optionally comprise one or more heteroatoms, e.g. oxygen, as part of a substituent, e.g. in a hydroxy group, or incorporated into the alkyl backbone, e.g. as an ether link. Examples of (meth)acrylic monomers are acrylic acid and salts thereof, methacrylic acid and salts thereof, acrylic anhydride, methacrylic anhydride, methyl acrylate, methyl methacrylate, ethyl acrylate, propyl acrylate, butyl acrylate, butyl methacrylate, propyl methacrylate, lauryl acrylate, 2-ethylhexylacrylate, ethyl methacrylate, isobornyl (meth)acrylate, hydroxyethyl (meth)acrylate, hydroxypropyl (meth)acrylate, polyethylene glycol (meth)acrylate, or tetrahydrofurfuryl acrylate. In embodiments, (meth)acrylic monomers include those where R is H or has from about 1 to 4 carbon atoms (e.g. from about 1 to 2 carbon atoms), for example methyl acrylate, methyl methacrylate and methacrylic acid. As used herein, the term “(meth)acrylic” refers to methacrylic and acrylic. As used herein, the term “(meth)acrylate” refers to acrylate and methacrylate. As used herein, the term “(meth)acrylic acid” refers to methacrylic acid and acrylic acid.

By vinyl ester monomers it is meant a compound and isomers thereof according to the general formula:

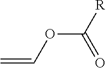

wherein R can be selected from an alkyl containing from about 1 to 20 (e.g. about 1 to 17) carbon atoms. In embodiments, R can optionally comprise one or more heteroatoms, e.g. oxygen, as part of a substituent, e.g. in a hydroxy group, or incorporated into the alkyl backbone, e.g. as an ether link. Examples of vinyl ester monomers include vinyl acetate, vinyl butyrate, vinyl stearate, vinyl laurate, vinyl myristate and vinyl propionate.

By nitrile containing monomers it is meant a compound and isomers thereof according to the general formula:

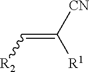

wherein R₁ and R₂ can be selected, separately from each other, from hydrogen and an alkyl containing from about 1 to 17 (e.g. about 1 to 4 or about 1 to 2) carbon atoms, or a nitrile group. In embodiments, R¹ and R² can optionally comprise one or more heteroatoms, e.g. oxygen, as part of a substituent, e.g. in a hydroxy group, or incorporated into the alkyl backbone, e.g. as an ether link. Examples of nitrile-containing monomers include acrylonitrile (R₁═R₂═H), methacrylonitrile (R₁═CH₃, R₂═H), fumaronitrile (R₁═CH₃, R₂═CN), crotonitrile (R₁═CH₃, R₂═CH₃). In embodiments, nitrile containing monomers can be selected from acrylonitrile and methacrylonitrile. As used herein, the term “(meth)acrylonitrile” refers to acrylonitrile and methacrylonitrile.

By (meth)acrylamide monomers it is meant a compound and isomers thereof according to the general formula:

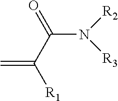

wherein R₁, R₂ and R₃ can be selected, separately from each other, from hydrogen and an alkyl containing from about 1 to 17 (e.g. about 1 to 4 or about 1 to 2) carbon atoms or hydroxyalkyl having from about 1 to 17 carbon atoms (e.g. about 1 to 4 or about 1 to 2), for example acrylamide (R₁═R₂═R₃═H), methacrylamide (R₁═CH₃, R₂═R₃═H), and N-substituted (meth)acrylamide monomers such as N,N-dimethylacrylamide (R₁═H, R₂═R₃═CH₃), N,N-dimethylmethacrylamide (R₁═R₂=R₃═CH₃), N-methylolacrylamide (R₁═H, R₂═H, R₃═CH₂OH). As used herein, the term “(meth)acrylamide” refers to methacrylamide and acrylamide.

By maleimide and N-substituted maleimide monomers is meant a compound according to the general formula:

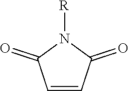

wherein R can be selected from hydrogen, an alkyl containing from about 1 to 17 carbon atoms, or halogen atom.

In embodiments, R is selected from H, CH₃, phenyl, cyclohexyl and halogen, and in further embodiments R is selected from phenyl and cyclohexyl.

In embodiments, the ethylenically unsaturated monomers not of Formula 1 are substantially free from vinyl aromatic monomers (e.g. styrenes). If they are present, such vinyl aromatic monomers can be present at less than 10 wt. %, for example less than 5 wt. %, less than 1 wt. % or less than 0.1 wt % of the total weight of the polymer (which can be calculated from the weight of vinyl aromatic monomer in the mixture of monomers used in the synthesis).

In still further embodiments, monomers not of Formula 1 can be selected from bio-derived monomers described in WO2019/043235 and WO2019/101749.

Thus, in embodiments, the co-polymer can comprise a lactone monomer of general formula:

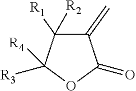

where R₁-R₄ are each independently selected from H and C₁₋₄ alkyl.

In other embodiments, the copolymer can comprise an itaconate dialkylester monomer of general formula:

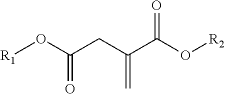

where each of R₁ and R₂ are separately selected from alkyl groups, for example C₁₋₄ alkyl groups.

Use of such bio-derived monomers can help further increase the bio-derived content of the polymeric shell of the microspheres.

In embodiments, at least one or more of the ethylenically unsaturated co-monomers not of Formula 1 is a nitrile-containing monomer and at least one of the one or more ethylenically unsaturated comonomers not of Formula 1 is selected from (meth)acrylic monomers (such as such as (meth)acrylic acid and (meth)acrylates), and itaconate dialkylester monomers. In further embodiments, at least one co-monomer is (meth)acrylonitrile and at least one co-monomer is selected from (meth)acrylic acid, C₁₋₁₂ alkyl(meth)acrylates (e.g. C₁₋₄ alkyl(meth)acrylates and methyl(meth)acrylates), and itaconate C₁₋₄ dialkyl esters (e.g. itaconate C₁₋₂ dialkyl esters). In embodiments, the comonomers are selected from acrylonitrile and dimethyl itaconate.

In embodiments, the content of monomer of Formula 1 in the polymer can be at least 1 wt %, for example at least 5 wt %, at least 10 wt % or at least 15 wt %. The content of monomer of Formula 1 in the polymer is less than 80 wt %, for example 75 wt % or less, such as 60 wt % or less, 50 wt % or 45 wt % or less. In embodiments, the content is in the range of from about 1 to less than 80 wt %, from about 1 to 75 wt %, from about 1 to 50 wt % or from about 1 to 45 wt %. In further embodiments, the content of monomer of Formula 1 is at least in the range of from about 5 to less than 80 wt %, from about 10 to less than 80 wt % or from about 15 to less than 80 wt %, for example in the range of from about 5 to 75 wt %, from about 5 to 60 wt %, from about 5 to 50 wt %, from about 5 to 45 wt %, from about 10 to 75 wt %, from about 10 to 60 wt %, from about 10 to 50 wt %, from about 10 to 45 wt %, from about 15 to 75 wt %, from about 15 to 60 wt %, from about 15 to 50 wt % or from about 15 to 45 wt %, each based on the total polymer weight.

The content of nitrile-containing monomers in the polymer is greater than 20 wt %, for example at least 25 wt % or at least 30 wt %, based on the total polymer weight. In embodiments, the nitrile content is no more than 95 wt % or no more than 75 wt %, for example no more than 60 wt %. Example ranges include from greater than about 20 wt % to 95 wt %, from greater than about 20 wt % to 75 wt %, from greater than about 20 to 60 wt %, from about 25 to 95 wt %, from about 25 to 75 wt %, from about 25 to 60 wt %, from about 30 to 95 wt %, from about 30 to 75 wt % or from 30 to 60 wt %. Preferably, the nitrile-containing monomers in the co-polymer are methacrylonitrile or acrylonitrile.

The content of other co-monomers not of Formula 1 in the thermoplastic polymer can be in the range of from about 0 to 75 wt %, or from about 0 to 50 wt %. Where used, their individual content in the thermoplastic polymer can be 2 wt % or more, for example 5 wt % or more or 10 wt % or more, with example ranges being from about 2 to 75 wt %, from about 5 to 75 wt % or from about 10 to 75 wt %, from about 2 to 50 wt %, from about 5 to 50 wt % or from about 10 to 50 wt %, each based on the total polymer weight.

In embodiments, the total bio-derived monomer content of the polymer is at least 10 wt %, for example at least 20 wt % or at least 30 wt %, for example in the range of from about 10 to less than 80 wt %, for example from about 20 to less than 80 wt % or from about 30 to less than 80 wt %, such as from about 10 to 75 wt %, from about 20 to 75 wt %, from about 30 to 70 wt %, each based on the total polymer weight.

In embodiments, the copolymer further comprises a monomer selected from itaconate dialkylester monomers, such as dimethyl itaconate, and the content of the itaconate dialkylester monomers, such as dimethyl itaconate, can be in the range of from about 1 to 50 wt % or from about 2 to 40 wt.-%. Preferably, the content of the itaconate dialkylester monomers, such as dimethyl itaconate, can also be from about 5 to 30 wt.-%, such as from about 10 to 20 wt.-%, each based on the total polymer weight.

In a preferred embodiment, the content of monomer of Formula 1 in the polymer is from about 1 to less than 80 wt %, from about 1 to 75 wt %, from about 1 to 50 wt %, from about 1 to 45 wt % from about 10 to 45 wt.-% or from about 15 to 45 wt.-% and the content of nitrile-containing monomers in the polymer is from greater than about 20 wt % to 95 wt %, from greater than about 20 wt % to 75 wt %, from about 25 to 60 wt %, or from about 30 to 60 wt %.

In a further preferred embodiment, the copolymer further comprises a monomer selected from itaconate dialkylester monomers, such as dimethyl itaconate, and the content of monomer of Formula 1 in the polymer is from 1 to less than 80 wt %, from about 1 to 75 wt %, from about 1 to 50 wt %, from about 1 to 45 wt % from about 10 to 45 wt.-% or from about 15 to 45 wt.-% and the content of nitrile-containing monomers in the polymer is from greater than about 20 wt % to 95 wt %, from greater than about 20 wt % to 75 wt %, from about 25 to 60 wt %, or from about 30 to 60 wt % and the content of the itaconate dialkylester monomers, such as dimethyl itaconate, is in the range of from about 1 to 50 wt % or from about 2 to 40 wt.-%, from about 5 to 30 wt.-%, or from about 10 to 20 wt.-%, each based on the total polymer weight.

In a particularly preferred embodiment, the copolymer further comprises dimethyl itaconate, and the content of monomer of Formula 1 in the polymer is from about 1 to 45 wt % from about 10 to 45 wt.-% or from about 15 to 45 wt.-% and the content of nitrile-containing monomers in the polymer is from 25 to 60 wt %, or from about 30 to 60 wt % and the content of the dimethyl itaconate is in the range of from about 2 to 40 wt.-%, from about 5 to 30 wt.-%, or from about 10 to 20 wt.-%, each based on the total polymer weight.

The monomer content of the polymer can be calculated from the weight proportion of monomers used in the polymer synthesis, i.e. the weight percentage of the monomer in the total weight of monomers used.

In a specific embodiment, the thermoplastic polymer shell of the thermoplastic polymeric microspheres comprises a copolymer consisting of or including:

about 10 to 80 wt %, based on the total polymer weight, of monomers of Formula 1 as defined below:

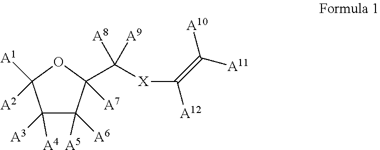

about 20 to 90 wt %, preferably about 30 to 80 wt. %, based on the total polymer weight, of nitrile-containing monomers, such as (meth)acrylonitrile, preferably acrylonitrile; and
about 0 to 50 wt % (preferably at least 1 wt %), based on the total polymer weight, of itaconate dialkylester monomers (e.g. dimethyl itaconate).

In a specific embodiment, the thermoplastic polymer shell of the thermoplastic polymeric microsphere comprises a copolymer consisting of or including:

about 10 to 70 wt %, based on the total polymer weight, of monomers of Formula 2, Formula 3 or Formula 4 as defined below:

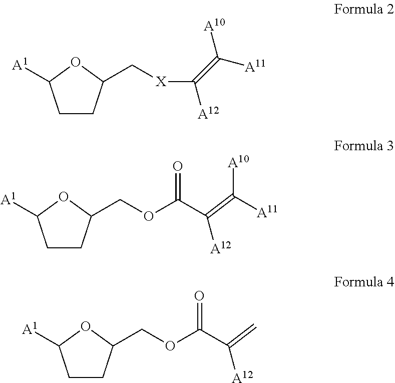

wherein A¹ is selected from H or C₁₋₄ alkyl optionally substituted with hydroxy, such as H, methyl or methoxy, particularly H or methoxy; and more particularly H;
   about 20 to 90 wt %, preferably about 30 to 80 wt. %, based on the total polymer weight, of nitrile-containing monomers, such as (meth)acrylonitrile, preferably acrylonitrile; and
   about 0 to 50 wt % (preferably at least 1 wt %), based on the total polymer weight, of itaconate dialkylester monomers (e.g. dimethyl itaconate).

In a further specific embodiment, the thermoplastic polymer shell of the thermoplastic polymeric microsphere comprises a copolymer consisting of or including:

about 10 to 60 wt %, based on the total polymer weight, of tetrahydrofurfuryl methacrylate;
about 30 to 90 wt %, based on the total polymer weight, of nitrile-containing monomers, such as (meth)acrylonitrile, preferably acrylonitrile; and
about 0 to 50 wt. %, preferably 1 to 50 wt %, based on the total polymer weight, of itaconate dialkylester monomers (e.g. dimethyl itaconate) or methyl(meth)acrylate.

In a still further specific embodiment, the thermoplastic polymer shell of the thermoplastic polymeric microsphere comprises a copolymer consisting of or including:

about 10 to 60 wt %, based on the total polymer weight, of tetrahydrofurfuryl methacrylate;
about 30 to 80 wt %, preferably 40 to 80 wt. %, based on the total polymer weight, of nitrile-containing monomers, such as (meth)acrylonitrile, preferably acrylonitrile; and
about 5 to 30 wt %, preferably 10 to 25 wt.-%, based on the total polymer weight, of itaconate dialkylester monomers (e.g dimethyl itaconate).

In a still further specific embodiment, the thermoplastic polymer shell of the thermoplastic polymeric microsphere comprises a copolymer consisting of or including:

about 15 to 45 wt %, based on the total polymer weight, of tetrahydrofurfuryl methacrylate;
about 30 to 80 wt %, preferably 40 to 75 wt. %, based on the total polymer weight, of nitrile-containing monomers, such as (meth)acrylonitrile, preferably acrylonitrile; and
about 5 to 30 wt %, preferably 10 to 25 wt.-%, based on the total polymer weight, of itaconate dialkylester monomers (e.g dimethyl itaconate).

### Crosslinking Multifunctional Monomers

In embodiments, the copolymer can comprise one or more crosslinking multifunctional monomers having more than one ethylenically unsaturated C═C bond. Examples of groups comprising ethylenically unsaturated C═C bonds include vinyl and allyl groups.

In embodiments, such crosslinking multifunctional monomers can be selected from compounds comprising from about 1 to 100 carbon atoms, including two or more ethylenically unsaturated C═C bonds. The compound can be a hydrocarbon, or can comprise one or more heteroatoms, such as O or N.

In embodiments, the compound comprises from about 1 to 12 carbon atoms, for example divinyl benzene, triallyl isocyanurate, 1,4-butanediol divinyl ether and trivinylcyclohexane

In other embodiments, the compound can be selected from esters comprising one or more (meth)acrylate groups, for example comprising from about 1 to 6 (meth)acrylate groups such as di, tri or tetra-esters. The ester groups can be attached to a hydrocarbon backbone comprising, for example, from about 1 to 60 carbon atoms or from about 1 to 40 carbon atoms, such as from about 1 to 20 carbon atoms or from about 1 to 10 carbon atoms. The hydrocarbon backbone can comprise one or more heteroatoms, for example one or more O or N atoms, for example in the form of ether, ester or amide linkages. Alternatively, or additionally, the hydrocarbon backbone can also comprise at least one ethylenically unsaturated C═C bond. For instance, in embodiments, the crosslinking multifunctional monomer can comprise a crosslinker comprising at least one ethylenically unsaturated C═C bond and attached to the crosslinker one more, preferably two, (meth)acrylate or (meth)acryloyl groups.

Examples of the crosslinking multifunctional monomers include one or more of ethylene glycol di(meth)acrylate, di(ethylene glycol) di(meth)acrylate, triethylene glycol di(meth)acrylate, propylene glycol di(meth)acrylate, 1,4-butanediol di(meth)acrylate, 1,6-hexanediol di(meth)acrylate, glycerol di(meth)acrylate, 1,3-butanediol di(meth)acrylate, neopentyl glycol di(meth)acrylate, 1,10-decanediol di(meth)acrylate, pentaerythritol tri(meth)acrylate, pentaerythritol tetra(meth)acrylate, dipentaerythritol hexa(meth)acrylate, triallylformal tri(meth)acrylate, allyl methacrylate, trimethylolpropane tri(meth)acrylate, tributanediol di(meth)acrylate, PEG #200 di(meth)acrylate, PEG #400 di(meth)acrylate, PEG #600 di(meth)acrylate, acrylated epoxidized soybean oil (e.g. Ebecryl 860), 3-acryloyloxyglycol monoacrylate, triacryl formal, or any combination thereof. In embodiments, one or more crosslinking monomers that are at least tri-functional are used. The amounts of crosslinking functional monomers may be from about 0 to 5 wt %, from about 0 to 3 wt % or from about 0 to 1 wt % of the total polymer weight, for example from about 0.1 to 5 wt. %, from about 0.1 to 3 wt. % or from about 0.1 to 1 wt. %. The content can be calculated from the amount of cross-linking functional monomer present in the monomer mixture used to synthesise the thermoplastic polymeric microspheres.

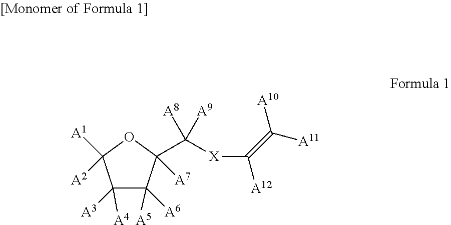

In Formula 1, each of A¹ to A¹¹ are independently selected from H and C₁ to C₄ alkyl, in which each C₁₋₄ alkyl group can optionally be substituted with one or more substituents selected from halogen, hydroxyhydroxy and C₁₋₄ alkoxy. A¹² is selected from C₁ to C₄ alkyl which can optionally be substituted with one or more substituents selected from halogen, hydroxyhydroxy and C₁₋₄ alkoxy

X is a linking group selected from —OC(O)—, —NR″C(O)— and —SC(O)—. The group C(O) represents a carbonyl group, C═O. R″ is H or C₁₋₂ alkyl optionally substituted with one or more substituents selected from halogen and hydroxy. In embodiments, X is selected from —OC(O)— and —NR″C(O)—. In particular preferred embodiments, X is —OC(O)—.

In embodiments, the total number of carbon atoms in A¹⁰ and A¹¹ is from 0 to 12, for example from about 0 to 6 carbon atoms.

In Formula 1, any of the following can apply:

### X is —OC(O)—

the optional substituent on the alkyl groups of A¹ to A¹² is hydroxy;
the alkyl groups of A¹ to A¹² are unsubstituted;
any or all of A¹ to A¹¹ are selected from H and optionally substituted C₁₋₂ alkyl;
One of A¹⁰ and A¹¹ is H and the other is H or C₁₋₂ unsubstituted alkyl;
A¹⁰ and A¹¹ are both H;
A¹² is selected from unsubstituted C₁₋₄ alkyl or unsubstituted C₁₋₂ alkyl;
A⁸ is H and A⁹ is H or unsubstituted C₁₋₂ alkyl;
A⁸ and A⁹ are both H;
any one or more of A¹ to A⁷ are selected from H and C₁₋₄ alkyl, for example C₁₋₂ alkyl, where each alkyl optionally is optionally substituted with one or more hydroxy groups;
A¹, A³, A⁵ and A⁷ are H, and A², A⁴ and A⁶ are each independently selected from H and C₁₋₂ alkyl, in which each alkyl is optionally substituted with one hydroxy group;
one of A¹ to A⁷, e.g. A¹, is monohydroxy-substituted C₁₋₂ alkyl, such as CH₂OH, and the rest are H;
no more than two of A¹ to A⁷ are unsubstituted C₁₋₂ alkyl, the rest being H;
all of A¹ to A⁷ are H;
all of A¹ to A⁹ are H;
all of A¹ to A¹¹ are H.

In embodiments, A² to A⁹ are all H, i.e. where the monomer is of Formula 2.

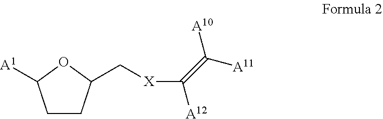

In embodiments, X is —OC(O)—, for example where the monomer is of Formula 3.

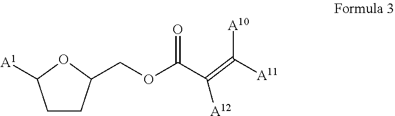

In embodiments, in Formula 3, both A¹⁰ and A¹¹ are H, such that the monomer is of Formula 4.

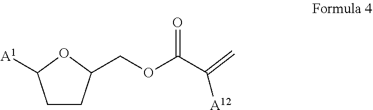

In embodiments, in Formula 2, 3 or 4, A¹ is H or C₁₋₄ alkyl optionally substituted with a hydroxyl group, e.g. C₁₋₂ alkyl optionally substituted with a hydroxyl group. In embodiments, A¹ is H, methyl or methoxy, for example being selected from H or methoxy.

In embodiments, in Formula 2, 3 or 4, A¹² is unsubstituted C₁₋₄ alkyl, for example ethyl or methyl.

In a specific embodiment, the thermoplastic polymer shell of the thermoplastic polymeric microsphere comprises a copolymer of a monomer of Formula 4 wherein A¹ is H and A¹² is methyl. The monomer of Formula 4 is then tetrahydrofurfuryl methacrylate (THFMA).

The monomers of Formula 1 can be produced from biomass via different routes. For example, they can be prepared from furfural, which is a by-product of many agricultural and other plant-based products such as corn cobs, oats, wheat bran, rice hulls, sugarcane and sawdust.

Furfural, or correspondingly substituted analogues, can be converted to monomers of Formula 1 by first producing a corresponding tetrahydrofurfuryl alcohol compound, e.g. by hydrogenation, using techniques described in U.S. Pat. No. 2,838,523 or WO2014/152366 for example. This alcohol compound can then be used, optionally after suitable conversion of the —OH functional group, to produce a monomer of Formula 1, e.g. through condensation reactions.

As an example, where X is —OC(O)—, esters of Formula 1 can be formed by acid catalysed esterification using corresponding unsaturated carboxylic acids, acyl halides or carboxylic acid anhydrides, as described for example in U.S. Pat. No. 3,458,561 or Lal & Green, J. Org. Chem., 1955, 20, 1030-1033. Alternatively, they can be made by creating an ester with a hydroxycarboxylic acid, followed by dehydration to produce the C═C double bond in the group attached to X, as described for example in U.S. Pat. No. 5,250,729. In further examples, transesterification can be used, as described for example in US475213.

### Microsphere and Polymer Shell Characteristics

The polymer shell softens at or above the glass transition temperature (T_{g}) of the polymer that constitutes the polymer shell. The blowing agent(s) within the core of the polymer shell is typically selected so that it begins to vapourise below the T_{g} of the thermoplastic polymer in the shell, thus causing expansion of the microsphere when the polymer is heated to above its softening temperature, i.e. above the T_{g}. It is also possible to select a blowing agent such that its boiling point is higher than the T_{g} of the polymer, but below its melting temperature, such that the shell softens first, before vapourisation takes place. However, this is less desirable, as the microspheres can become distorted, which potentially causes inhomogeneous and less efficient expansion.

The temperature at which the expansion starts is called Tₛₜₐᵣₜ, while the temperature at which maximum expansion is reached is called Tₘₐₓ. In some applications it is desirable that the microspheres have a high Tₛₜₐᵣₜ and high expansion capability, so as to be used in high temperature applications like foaming of thermoplastic materials in e.g. extrusion or injection moulding processes. Tₛₜₐᵣₜ for the expandable microspheres is in embodiments from about 50 to 250° C., for example from about 60 to 200° C., or from about 70 to 150° C. Tₘₐₓ for the expandable microspheres is in embodiments in the range of from about 70 to 300° C., most preferably from for example from about 75 to 230° C. or from about 80 to 160° C.

The T_{g} of the polymer, or at least one of the polymers, that constitutes the polymer shell can be the same as or below the Tₛₜₐᵣₜ.

Tₘₐₓ is typically below the melting point of the polymer that constitutes the polymer shell, to avoid collapse of the expanded microspheres.

The expandable microspheres preferably have a volume median diameter from about 1 to 500 μm, more preferably from about 3 to 200 μm, most preferably from about 3 to 100 μm.

The term expandable microspheres as used herein refers to expandable microspheres that have not previously been expanded, i.e. unexpanded expandable microspheres.

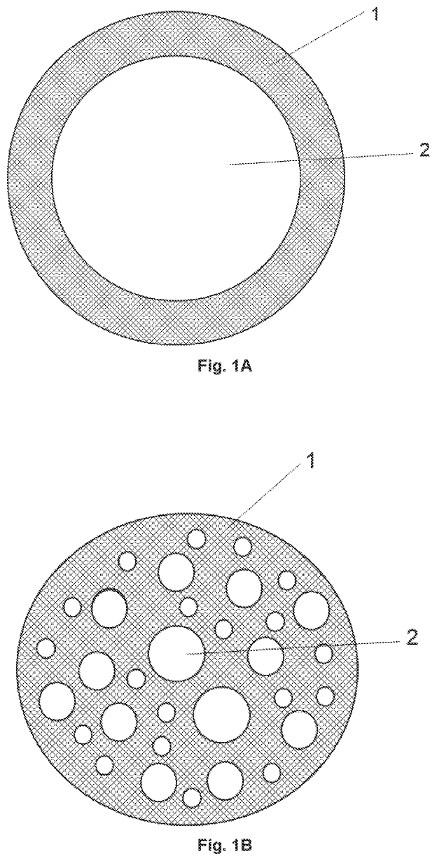

In the expandable polymeric microspheres, the thermoplastic polymer shell surrounds a hollow core or cavity, which contains the blowing agent. The microsphere ideally comprises just a single core, as opposed to so-called multi-core microspheres. These are illustrated in FIGS. 1A and 1B, where 1 indicates the thermoplastic polymer, and 2 indicates hollow regions that contain blowing agent. In FIG. 1B, there is no polymeric shell as such, the structure more being representative of a polymeric bead comprising pockets of blowing agent in a foam- or cellular-type structure. Therefore, the term “core-shell” distinguishes the single core microspheres from the foam/cellular structure that is associated with multiple core microspheres.

Single core microspheres have significantly improved expansion characteristics compared to multi core microspheres or foams, because they tend to comprise more blowing agent per unit mass of polymer. Thus, in embodiments, in a given batch or collection of expandable microspheres, at least 60% by mass are single core microspheres (with a core/shell structure as opposed to a foam/cellular structure), and in further embodiments at least 80% by mass, such as at least 90% or at least 95% by mass.

### [Expansion of Expandable Microspheres]

Expansion is achieved by heating the expandable microspheres at a temperature above Tₛₜₐᵣₜ. The upper temperature limit is set by when the microspheres start collapsing and depends on the exact composition of the polymer shell and the blowing agent. The ranges for the Tₛₜₐᵣₜ and Tₘₐₓ (defined further below) can be used for finding a suitable expansion temperature.

The density of the expanded microspheres can be controlled by selecting temperature and time for the heating. Heating can be by any suitable mechanism, for example using devices as described in EP0348372, WO2004/056549 or WO2006/009643.

The expandable microspheres can be expanded by heating, either in a dry form or in a liquid suspending medium, which in embodiments is an aqueous medium. In embodiments, the resulting expanded microspheres may contain less blowing agent. This is because, on microspheres expansion, the thermoplastic polymer shell becomes thinner, which can make it more permeable to the more blowing agent.

The expansion typically results in a particle diameter from 1.5 to 8, for example 2 to 5 times larger than the diameter of the unexpanded microspheres. After expansion, the density of the microspheres is typically less than 0.6 g/cm³. In preferred embodiments, the density of the expanded microspheres is 0.06 or less, for example in the range of from about 0.005 to 0.06 g/cm³. Typically, where the density of the heated particles is 1 g/cm³ or more, then either the microspheres have not expanded, or there is substantial agglomeration of the microspheres.

The volume median diameter of the expanded microspheres is typically 750 μm or below, for example 500 μm or below or, more usually, 300 μm or below. The volume mean diameter of the expanded microspheres is also typically 5 μm or more, for example 7 μm or more, 10 μm or more, or 20 μm or more. Example ranges include about 5 to 750 μm, about 5 to 500 μm, about 5 to 300 μm, about 7 to 750 μm, about 10 to 300 μm, about 20 to 750 μm, about 20 to 500 μm or about 20 to 300 μm.

### Blowing Agent

In embodiments, the blowing agent, sometimes referred to as a foaming agent or a propellant, is selected such that it has a sufficiently high vapour pressure at temperatures above the T_{g} of the thermoplastic shell to enable expansion of the microspheres.

In embodiments, the boiling temperature (at atmospheric pressure) of the blowing agent, or at least one of the blowing agents, is not higher than the T_{g} of the polymer constituting the thermoplastic polymer shell. In embodiments, the boiling point at atmospheric pressure of the blowing agent can be in the range of from about −50 to 250° C., for example from about −20 to 200° C., or from about −20 to 100° C. In embodiments, the amount of the blowing agent in the expandable microspheres is at least 5 wt % or in embodiments at least 10 wt %. In embodiments, the maximum amount of blowing agent in the microspheres is 60 wt. %, for example 50 wt. %, 35 wt. % or 25 wt %, based on the total weight of the microspheres. Example ranges include from about 5 to 60 wt %, from about 5 to 50 wt %, from about 5 to 35 wt %, from about 5 to 25 wt %, from about 10 to 60 wt %, from about 10 to 50 wt %, from about 10 to 35 wt % and from about 10 to 25 wt %.

The blowing agent can be a hydrocarbon, for example a hydrocarbon with 1 to 18 carbon atoms, such as from about 3 to 12 carbon atoms, and in embodiments from about 4 to 10 carbon atoms. The hydrocarbon can be a saturated or unsaturated hydrocarbon. The hydrocarbon can be aliphatic or aromatic, typically aliphatic (which includes branched, linear and cyclic hydrocarbons). Aliphatic hydrocarbons are typically unsaturated. In embodiments, the hydrocarbon is selected from C₄ to C₁₂ alkanes, for example linear or branched alkanes such as n-butane, isobutane, n-pentane, isopentane, cyclopentane, neopentane, hexane, isohexane, neo-hexane, cyclohexane, heptane, isoheptane, octane, isooctane, decane, dodecane and isododecane. In embodiments, the hydrocarbon is selected from C₄ to C₁₀ alkanes.

Further examples of blowing agents include dialkyl ethers and halocarbons, e.g. chlorocarbons, fluorocarbons or chlorofluorocarbons. The dialkyl ether can comprise two alkyl groups each selected from C₂ to C₅ alkyl groups, for example C₂-C₃ alkyl groups. The halocarbon can be a C₂ to C₁₀ halocarbon comprising one or more halogen atoms that are, in embodiments, selected from chlorine and fluorine. In embodiments, the halocarbon is a haloalkane, such as a C₂ to C₁₀ haloalkane. The alkyl or haloalkyl groups in the dialkyl ethers and haloalkanes can be linear, branched or cyclic.

The blowing agent can be a single compound or a mixture of compounds. For example, mixtures of any one or more of the above-mentioned blowing agents can be used.

In embodiments, for environmental reasons, the one or more blowing agents are selected from (di)alkyl ethers and hydrocarbons, for example alkanes. In further embodiments the one or more blowing agents are selected from alkanes. Haloalkanes are preferably avoided, due to their potential ozone depletion properties, and also due to their generally higher global warming potential. Saturated hydrocarbons are preferred over unsaturated hydrocarbons, because the latter could potentially undergo side reactions with the monomers that are used to prepare the thermoplastic polymeric shell. This can reduce the blowing agent quantity in the hollow core, or even disrupt formation of the polymeric microspheres.

### Production of Microspheres

The microspheres can be prepared in a suspension polymerisation process. In the process, an aqueous dispersion (or emulsion) of organic droplets comprising monomers and blowing agent is polymerised in the presence of a free-radical initiator, where at least one of the monomers is according to Formula 1 and at least one of the monomers is a nitrile-containing monomer.

Typical ways of doing this include processes described in U.S. Pat. Nos. 3,615,972, 3,945,956, 4,287,308, 5,536,756, EP0486080, U.S. Pat. No. 6,509,384, WO2004/072160 and WO2007/091960.

In a typical process of suspension polymerization, the monomer(s) and the blowing agent(s) are mixed together to form a so called oil-phase or organic phase. The oil-phase is then mixed with an aqueous mixture, for example by stirring or agitation, to form a fine dispersion of droplets, which can be in the form of an emulsion. The droplet size of the emulsion or dispersion can be manipulated, and they typically have a median diameter of up to 500 μm, and typically in a range of about 3-100 μm. The dispersion or emulsion may be prepared by devices known in the art.

The dispersion or emulsion may be stabilised with so called stabilising chemicals, or suspending agents, as known in the art such as surfactants, polymers or particles.

### Emulsion Stabilisers

In embodiments, an emulsion is formed. In further embodiments, the emulsion is stabilised by a so-called “Pickering Emulsion” processes. Stabilisation of the emulsion droplets is preferred for a number of reasons; without stabilisation a coalescence of the emulsion droplets containing the monomers and the blowing agents may occur. Coalescence has negative effects; such as, a non-uniform emulsion droplet size distribution resulting in undesirable proportions of emulsion droplets with different sizes, which in turn leads to undesirable properties of thermally expandable microspheres after polymerization. Furthermore, stabilisation prevents aggregation of thermally expandable microspheres. In addition, stabilisation may prevent formation of non-uniform thermally expandable microspheres and/or the formation of a non-uniform thermoplastic shell and an incomplete thermoplastic shell of the thermally expandable microspheres. The suspending agent is preferably present in an amount of up to 20 wt. %, for example from about 1 to 20 wt % based on the total weight of the monomer(s).

In some embodiments, the suspending agent is selected from salts, oxides and hydroxides of metals such as Ca, Mg, Ba, Zn, Ni and Mn, for example one or more selected from calcium phosphate, calcium carbonate, magnesium hydroxide, magnesium oxide, barium sulphate, calcium oxalate, and hydroxides of zinc, nickel and manganese. These suspending agents are suitably used at a high pH, preferably from about 5 to 12, most preferably from about 6 to 10. Preferably magnesium hydroxide is used. However, sometimes alkaline conditions need to be avoided, for example where the monomer of Formula 1 or the resulting polymer may be prone to hydrolysis.

Therefore, in embodiments, it may be advantageous to work at a low pH, for example in the range of from about 1 to 6, such as in the range of from about 3 to 5. A suitable suspending agent for this pH range is selected from starch, methyl cellulose, hydroxypropyl methylcellulose, hydroxypropyl methylcellulose, carboxy methylcellulose, gum agar, silica, colloidal clays, oxide and hydroxide of aluminium or iron. In preferred embodiments, silica is used.

Where silica is used, it can be in the form of a silica sol (colloidal silica), which is typically an aqueous silica sol comprising silica particles.

The silica particles can provide a stabilising protective layer at the interface between the organic and aqueous phase during the polymerisation process, which prevents or reduces coalescence of the suspended or emulsified organic-phase droplets.

The silica particles can be combined with one or more co-stabilisers, for example as disclosed in U.S. Pat. No. 3,615,972. The co-stabilisers can be selected from: metal ions (such as Cr(III), Mg(II), Ca(II), Al(III) or Fe(III)) and flocculants (such as a poly-condensate oligomer of adipic acid and diethanol amine) optionally with a reducing agent.

In embodiments, the surface of the colloidal silica particles can be modified with one or more metal ions to produce so-called “charge-reversed” silica sols. Such surface modification includes modification with moieties that comprise elements that formally adopt a +3 or +4 oxidation state. Examples of such modifying elements include boron, aluminium, chromium, gallium, indium, titanium, germanium, zirconium, tin and cerium. Boron, aluminium, titanium and zirconium are particularly suitable for modifying the silica surface, especially aluminium-modified aqueous silica sols. These can be prepared using known methods, for example as described in U.S. Pat. Nos. 3,007,878, 3,139,406, 3,252,917, 3,620,978, 3,719,607, 3,745,126, 3,864,142 and 3,956,171.

In embodiments, the surface can comprise one or more organic groups, for example after being modified with one or more organosilane compounds. Typical organosilane groups which can be on the silica surface include those described in WO2018/011182 and WO2018/213050. Thus, the organosilane moiety can be represented by group E-Si≡, where —Si≡ is a silicon atom from the silane moiety that is bound to the surface of the silica particle via one or more siloxane (—Si—O—Si) bonds.

E is an organic group that can be selected from alkyl, epoxy alkyl, alkenyl, aryl, heteroaryl, C₁₋₆ alkylaryl and C₁₋₆ alkylheteroaryl. These can optionally be substituted with one or more groups selected from —R^{a} or -LR^{a}. L, when present, is a linking group selected from —O—, —S—, —OC(O)—, —C(O)O—, —C(O)OC(O)—, —C(O)OC(O)—, —N(R^{b})—, —N(R^{b})C(O)—, —N(R^{b})C(O)N(R^{b})— and —C(O)N(R^{b})—.

R^{a} can be selected from hydrogen, F, Cl, Br, alkyl (e.g. C₁₋₆ alkyl), alkenyl (e.g. C₁₋₆ alkenyl), aryl (e.g. C₅₋₈ aryl), heteroaryl (e.g. C₅₋₈ heteroaryl comprising at least one heteroatom selected from O, S and N); C₁₋₃ alkyl-aryl and C₁₋₃ alkyl-heteroaryl. Alkyl groups can be C₁₋₆ alkyl. Aryl groups can be those with a 5 to 8 membered ring. Heteroaryl groups can those with a 5-8 membered rings, comprising at least one heteroatom selected from O, S and N. The R^{a} groups can optionally be substituted with one or more groups selected from OH, F, Cl, Br, epoxy, —C(O)OR^{b}, —OR^{b} and —N(R^{b})₂. R^{b} is H or C₁₋₆ alkyl.

In embodiments, E can comprise one or more groups selected from hydroxy, thiol, carboxyl, ester, epoxy, acyloxy, ketone, aldehyde, (meth)acryloxy, amino, mercapto, amido and ureido. In embodiments, E can comprise an epoxy group or one or more hydroxy groups.

In specific examples, E can be selected from one or more groups selected from C₁₋₆ alkyl optionally substituted with an epoxy group, a (meth)acrylamido group or one or more hydroxy groups. In embodiments, E can be —R^{c}—O—R^{d}, where R^{c} is C₁₋₆ alkyl and R^{d} is a C₁₋₆ alkyl optionally modified with an epoxy group or one or more hydroxy groups.

Specific examples of E include 3-glycidoxypropyl, dihydroxypropoxypropyl [e.g. HOCH₂CH(OH)CH₂OC₃H₆—], and methacrylamidopropyl.

Organosilane-modified colloidal silica can be made using procedures described in US2008/0245260, WO2012/123386, WO2004/035473 and WO2004/035474.

In terms of the proportion of surface modification, this can be expressed in units of μmol modifying group per square metre of colloidal silica surface. In embodiments, the surface coverage from the one or more organic groups is in the range of from about 0.35 to 3.55 μmol/m², for example from about 0.35 to 2.82 μmol/m², or from about 0.77 to 2.82 μmol/m².

### Co-Stabilisers

In order to enhance the effect of the suspending agent, it is also possible to add small amounts of one or more co-stabilisers. In embodiments, the amount of co-stabiliser is present in amounts of up to 1 wt %, for example from about 0.001 to 1 wt %, based on the total weight of the monomer(s). Co-stabilisers can be organic materials which can be selected, for example, from one or more of water-soluble sulfonated polystyrenes, alginates, carboxymethylcellulose, tetramethyl ammonium hydroxide or chloride or water-soluble complex resinous amine condensation products such as the water-soluble condensation products of diethanolamine and adipic acid, the water-soluble condensation products of ethylene oxide, urea and formaldehyde, polyethylenimine, polyvinylalcohol, polyvinylpyrrolidone, polyvinylamine, amphoteric materials such as proteinaceous, materials like gelatin, glue, casein, albumin, glutin and the like, non-ionic materials like methoxycellulose, ionic materials normally classed as emulsifiers, such as soaps, alkyl sulphates and sulfonates and long chain quaternary ammonium compounds.

### Proportions

In a suitable, typically batch-wise, procedure for preparing the expandable microspheres, the polymerization is conducted in a reaction vessel. In embodiments, the procedure includes preparing a mixture comprising or consisting of 100 parts of the monomer phase, which includes the monomer(s), the blowing agent(s); 0.1 to 5 parts of a polymerisation initiator; 100-800 parts of the aqueous phase; and 1 to 20 parts of a suspending agent. The mixture is then homogenised. The droplet size of the monomer phase determines the size of the final expandable microspheres, in accordance with the principles described in e.g. U.S. Pat. No. 3,615,972, which can be applied for all similar production methods with various suspending agents. The required pH depends on the suspending agent used, as described above.

### Initiator

The emulsion obtained is subjected to conventional radical polymerization using at least one initiator. Typically, the initiator is used in an amount from 0.1 to 5 wt. % based on the weight of the monomer phase. Conventional radical polymerization initiators are selected from one or more of organic peroxides such as dialkyl peroxides, diacyl peroxides, peroxy esters, peroxy dicarbonates, or azo compounds. Suitable initiators include dicetyl peroxydicarbonate, di(4-tert-butylcyclohexyl) peroxydicarbonate, dioctanyl peroxide, dibenzoyl peroxide, dilauroyl peroxide, didecanoyl peroxide, tert-butyl peracetate, tert-butyl perlaurate, tert-butyl perbenzoate, tert-butyl hydroperoxide, cumene hydroperoxide, cumene ethylperoxide, diisopropylhydroxy dicarboxylate, 2,2′-azo-bis(2,4-dimethyl valeronitrile), 2,2′-azobis(2-methylpropionate), 2,2′-azobis[2-methyl-N-(2-hydroxyethyl)propionamide] and the like. It is also possible to initiate the polymerization with radiation, such as high energy ionising radiation, UV radiation in combination with a photoinitiator or microwave-assisted initiation.

When the polymerization is essentially complete, microspheres are normally obtained as an aqueous slurry or dispersion, which can be used as such or dewatered by any conventional mechanism, such as bed filtering, filter pressing, leaf filtering, rotary filtering, belt filtering or centrifuging to obtain a so called wet cake. It is also possible to dry the microspheres by any conventional mechanism, such as spray drying, shelf drying, tunnel drying, rotary drying, drum drying, pneumatic drying, turbo shelf drying, disc drying or fluidised bed drying, to produce powdered microspheres. Microspheres can be provided in suspended (e.g. as an aqueous suspension), wet (e.g. wet-cake) or dry (e.g. powdered) form. They can be provided either in pre-expanded or in expanded form.

### Residual Monomer Reduction

If appropriate, the microspheres may at any stage be treated to reduce or further reduce the amount of residual unreacted monomers, for example by any of the procedures described in WO2004/072160 or U.S. Pat. No. 4,287,308.

The presence of residual monomers is undesirable, as their reactivity can make the microspheres less desirable for applications such as food, drink and pharmaceuticals packaging.

For instance, the microspheres may be treated with an agent such as certain oxo acids of sulfur, or salts or derivatives thereof to reduce or further reduce the amount of residual unreacted monomers, such as one or more of acrylonitrile, methacrylonitrile and monomers according to formula 1, such as tetrahydrofurfuryl (meth)acrylate.

In one embodiment, the microspheres are treated with an agent reacting directly or indirectly with at least part of said residual monomers, wherein said agent is selected from oxo acids of sulfur, salts and derivatives thereof, comprising at least one sulfur atom having at least one free electron pair and binding three oxygen atoms or comprising at least two sulfur atoms which are linked via a peroxide group. It has surprisingly been found that with such treatment the residual amount of monomer in the microspheres can be reduced to less than 2,000 ppm, such as for instance less than 1,000 ppm, particularly less than 500 ppm.

According to a preferred embodiment, the microspheres are treated with an agent selected from the oxo acids of sulphur, salts and derivatives thereof, comprising at least two sulfur atoms which are linked together via a peroxide group. Particular preferred are persulfates. It has surprisingly been found that with such persulfate treatment the residual amount of monomer in the microspheres can be further reduced to less than 500 ppm, such as for instance less than 300 ppm, particularly less than 200 ppm and even less than 100 ppm. Surprisingly, the persulfate treatment may reduce in particular the amount of residual acrylonitrile in the microspheres to less than 500 ppm, such as for instance less than 300 ppm, particularly less than 200 ppm and even less than 100 ppm or less than 50 ppm.

The agent may be added as such or be formed in situ through one or more chemical reactions from a precursor.

Suitable agents for the agent selected from oxo acids of sulfur, salts and derivatives thereof, comprising at least one sulfur atom having at least one free electron pair and binding three oxygen atoms include bisulfites (also called hydrogen sulfites), sulfites and sulfurous acid, of which bisulfites and sulfites are preferred. Suitable counter ions include ammonium and mono- or divalent metal ions such as alkali metal and alkaline earth metal ions. Most preferred are sodium, potassium, calcium, magnesium and ammonium. Also organic compounds comprising any of the above groups may be used, such as alkyl sulfites or dialkyl sulfites. Particularly preferred agents are dimethyl sulfite, sodium bisulfite, sodium sulfite, and magnesium bisulfite. Most preferred is sodium bisulfite.

Examples of precursors include sulfur dioxide, sulfonyl chloride, disulfites (also called metabisulfites or pyrosulfites), ditionites, ditionates, sulfoxylates, e. g. of sodium, potassium or other counter ions as defined above. Preferred precursors are sulfur dioxide, disulfites and ditionites. Particularly preferred precursors are sodium metabisulfite, potassium metabisulfite and sodium ditionite. To the extent corresponding acids exist, they are also useful. The precursors can easily react to form an active agent as defined above, e. g. by redox reactions and/or by simply being dissolved in an aqueous medium.

Suitable agents for the agent selected from oxo acids of sulfur, salts and derivatives thereof, comprising at least two sulfur atoms which are linked via a peroxide group include persulfates, such as for instance sodium persulfate, potassium persulfate or ammonium persulfate. Preferred is sodium persulfate. To the extent corresponding acids exist, they are also useful.

It has been found that an agent as defined above reacts directly or indirectly with monomers without negatively affecting important properties of the microspheres, such as the degree of expansion that can be achieved. Furthermore, reaction products remaining on or in the microspheres are less toxic than e. g. acrylonitrile and do not cause any significant problem of discolouration.

During the step of contacting the microspheres with the agent for reacting with residual monomers, the microspheres are preferably in the form of an aqueous slurry or dispersion, preferably comprising from about 0.1 to about 50 wt % microspheres, most preferably from about 0.5 to about 40 wt % microspheres, while the agent is preferably dissolved in the liquid phase, preferably at a concentration from about 0.1 wt % up to the saturation limit, most preferably from about 1 to about 40 wt %. However, the microspheres could alternatively be suspended in any other liquid medium which dissolves the agent, or mixtures thereof. Preferably, the slurry or dispersion originates from the polymerisation mixture in which the microspheres have been produced.

Without being bound to any theory, it is believed that addition of an agent or precursor as earlier defined result in a solution comprising sulphite, bisulfite, or persulfate which in turn reacts with the monomers.

The amount of agent, expressed as moles sulfur atoms having at least one free electron pair and binding three oxygen atoms or moles peroxide groups linking two sulfur atoms, compared to the molar amount of residual monomers, is preferably at least about equimolar, more preferably from about equimolar to about 200% excess, most preferably from about equimolar to about 50% excess on a molar basis, particularly most preferably from about equimolar to about 25% excess on a molar basis. If the slurry or dispersion originates from the polymerisation mixture and thus contains residual monomer also in the liquid phase, these monomers have to be taken into account in addition to those present in or on the microspheres.

The agent or precursor for the agent reacting with residual monomers may be added during the production of the microspheres, optionally when the polymerisation still is running, although it is preferred that at the time for addition of the agent or precursor the polymerisation is almost complete and less than 15% preferably less than 10% residual monomers remain. The agent or precursor is preferably added when the microspheres has formed but still are in a slurry or dispersion and most preferably when they still are in the same reaction vessel as the polymerisation has been conducted in.

Alternatively, the agent or precursor may be added to the microspheres in a separate step after the microspheres have been removed from the polymerisation reactor, optionally after any of subsequent operations such as dewatering, washing or drying. The non-treated microspheres comprising residual monomers could then be regarded as an intermediate product, which optionally can be transported to another location and there being brought into contact with the agent for removing residual monomers.

In any of the above options, the agent or precursor may be added all at once or in portions.

The pH during the step of contacting the microspheres with the agent is preferably from about 3 to about 12, most preferably from about 3.5 to about 10. The temperature during said step is preferably from about 20 to about 100 C, most preferably from about 50 to about 100 C, particularly most preferably from about 60 to about 90 C.

The pressure during said step is preferably from about 1 to about 20 bar (absolute pressure), most preferably from about 1 to about 15 bar. The time for said step is preferably at least about 5 minutes, most preferably at least about 1 hr. There is no critical upper limit, but for practical and economic reasons the time is preferably from about 1 to about 10 hours, most preferably from about 2 to about 5 hours. After said step, the microspheres preferably are dewatered, washed and dried by any suitable conventional mechanism.

### Uses of Microspheres

The expandable and expanded microspheres of the present disclosure are useful in various applications, typically as a foaming agent and/or as a low density filler.

Examples of applications where the microspheres can be used include the production of foamed or low density resins, paints, coatings (e.g. anti-slip coatings, solar reflective, insulating coatings and underbody coatings), adhesives, cements, inks (e.g. printing inks such as waterborne inks, solvent borne inks, plastisol inks, thermal printer paper, and UV curing inks), paper and board, porous ceramics, non-woven materials, shoe soles such as sports shoe soles, textured coverings, artificial leather, food packaging, crack fillers, putties, sealants, toy-clays, wine corks, explosives, cable insulations, foams for protective helmet liners, and automotive weather strips. Microspheres can also be used in the in the treatment or processing of natural leather, for example to remove defects, to improve the aesthetic appearance, or to increase thickness.

The microspheres can also be used in producing polymer or rubber materials. Examples include thermoplastics (e.g. polyethylene, polyvinyl chloride, poly(ethylene-vinylacetate), polypropylene, polyamides, poly(methyl methacrylate), polycarbonate, acrylonitrile-butadiene-styrene polymer, polylactic acid, polyoxymethylene, polyether ether ketone, polyetherimide, polyether sulfone, polystyrene and polytetrafluoroethylene), thermoplastic elastomers (e.g. styrene-ethylene-butylene-styrene copolymer, styrene-butadiene-styrene copolymer, thermoplastic polyurethanes and thermoplastic polyolefins); styrene-butadiene rubber; natural rubber; vulcanized rubber; silicone rubbers; and thermosetting polymers (e.g. epoxies, polyurethanes and polyesters).

In some of these applications expanded microspheres are particularly advantageous, such as in putties, sealants, toy-clays, genuine leather, paint, explosives, cable insulations, porous ceramics, and thermosetting polymers (like epoxies, polyurethanes and polyesters). In some cases it is also possible to use a mixture of expanded and expandable microspheres of the present disclosure, for example in underbody coatings, silicone rubbers and light weight foams.

### EXAMPLES

The present disclosure will be further described in connection with the following, non-limiting examples. If not otherwise stated, all parts and percentages are weight parts or weight percentages.

### Analysis Details

The expansion properties were evaluated on dry particles on a Mettler Toledo TMA/SDTA851^{e} thermomechanical analyser, interfaced with a PC running with STAR^{e} software. The sample to be analysed was prepared from 0.5 mg (+/−0.02 mg) of the thermally expandable microspheres contained in an aluminum oxide crucible with a diameter of 6.8 mm and a depth of 4.0 mm. The crucible was sealed using an aluminum oxide lid with a diameter of 6.1 mm. Using a TMA Expansion Probe type, the temperature of the sample was increased from about 30° C. to 240° C. with a heating rate of 20° C./min while applying a load (net.) of 0.06 N with the probe. The displacement of the probe vertically was measured to analyze the expansion characteristics.

Initial temperature of expansion (Tₛₜₐᵣₜ): the temperature (° C.) when displacement of the probe is initiated, i.e. the temperature at which the expansion start;

Maximum temperature of expansion (Tₘₐₓ): the temperature (° C.) when displacement of the probe reaches its maximum, i.e. the temperature at which maximum expansion is obtained;

Maximum displacement (Lₘₐₓ): the displacement (μm) of the probe when displacement of the probe reaches its maximum;

TMA density: sample weight (d) divided by volume increase of the sample (dm³) when displacement of the probe reaches its maximum. The lower the TMA density, the better the microspheres expand and a lower TMA-density usually indicates more desirable expansion properties. A TMA density of 0.2 g/cm³ or lower is considered to be desirable and a TMA density of at least 0.15 g/cm³ or lower is considered to be particularly desirable.

The particle size and size distribution was determined by laser light scattering on a Malvern Mastersizer Hydro 2000 SM apparatus on wet samples. The median particle size is presented as the volume median diameter, D(50). The span is calculated from [D90−D10]/D50, where D90 is the diameter which encompasses 90% of the microspheres, and D10 is the diameter which encompasses 10% of the microspheres, on a volume basis.

The amount of the blowing agent was determined by thermal gravimetric analysis (TGA) on a Mettler Toledo TGA/DSC 1 with STAR^{e} software. All samples were dried prior to analysis in order to exclude as much moisture as possible and if present also residual monomers. The analyses were performed under an atmosphere of nitrogen using a heating rate at 25° C. min⁻¹ starting at 30° C. and finishing at 650° C.

The amount of residual monomers in the obtained microsphere slurry was determined after solvent extraction using gas chromatography using using a Gas Chromatograph (GC) equipped with a Flame Ionization Detector (FID) and a polar separation column. A defined aliquot of microsphere slurry, along with a defined amount of internal standard is extracted with acetone under stirring for 3 hours. The extracted sample is centrifuged, and a part of the supernatant is transferred in to a GC sample vial. The residual concentration of each monomer in the slurry sample is analyzed with GC-FID (Gas Chromatograph equipped with a Flame Ionization Detector) where the different monomers are separated on a polar Agilent InnoWax column. The total amount of residual monomers determined for the microspheres are specified in Table 4 below. The amounts of the individual residual monomers for the microspheres of some examples after the treatment with sodium bisulfite or sodium persulfate are specified in Table 6 below.

### Synthetic Procedure

Thermoplastic core/shell microspheres were prepared according to the following general procedure using the components and amounts specified in Tables 1-3 below.

An organic phase was prepared by mixing monomers, cross linking agent and blowing agent(s) in a stirring vessel. This was then mixed with an aqueous phase that comprised stabiliser, the polymerisation initiator, sodium hydroxide and acetic acid, these last two components being added to ensure the pH of the aqueous phase was approximately 4.5.

In a typical experiment, the content of the aqueous phase was as follows:

| | |
|---|---|
| Added water: | 362.5 g |
| NaOH (1M) | 15.8 g |
| Acetic Acid (10%) | 25.3 g |
| Stabiliser (Silanized Colloidal Silica) | 32.0 g |
| Initiator (35% Dicetyl peroxydicarbonate) | 7.5 g |
| Rinse water | 50.0 g |

Rinse water refers to water that was used to flush the inlet pipes to the reactor after the various components had been added.

The mixture was stirred vigorously using a propellor mixer to form a homogeneous dispersion. The oil (organic) phase content of the mixture was 40 wt %. The monomer mixtures of the various Examples are shown in Table 1. The oil phase composition is shown in Table 2, and the aqueous phase composition is shown in Table 3.

### Examples 1-21

The aqueous and organic phases were transferred to a 1 L volume rotator/stator reactor. Under constant stirring, polymerisation was initiated by raising the temperature to 57° C. and holding at that temperature for 5 hours. The reactor temperature was then raised to 63° C., and the temperature held for 4 hours, under the same mixing conditions. A 20 wt % aqueous solution of sodium bisulfite was then added at a temperature of 70° C. in order to reduce levels of any residual unreacted monomer. The amount added was selected to ensure that the amount of sodium bisulfite (on a dry basis) was 14 wt % of the total organic phase. The temperature was then held for 4.5 h, before being allowed to cool to room temperature.

The slurry was filtered through a 63 μm filter, to remove agglomerated particles. The resulting microspheres were then analysed for density, particle size, expansion characteristics, amount of filtered agglomerated material, and long term-stability (i.e. expansion characteristics after 4 months). The results are presented in Tables 4 and 5.

### Example 22

The microspheres of Example 22 were prepared according to an analogous procedure as set forth about for Examples 1-21 with the only modification that the amount of sodium bisulfite added was selected to ensure that the amount of sodium bisulfite (on a dry basis) was 5.7 wt % of the total organic phase.

### Examples 23-25

The microspheres of Examples 23-25 were prepared according to the same method as set forth about for Examples 1-21 with the only modification that instead of sodium bisulfite a 25 wt % aqueous solution sodium persulfate was added at a temperature of 73° C. in order to reduce levels of any residual unreacted monomer. The amount added was selected to ensure that the amount of sodium persulfate (on a dry basis) was 5.7 wt % of the total organic phase.

TABLE 1
Monomer Composition of Organic Phase (1)

| Example | ACN (2) | DMI (3) | TFHMA (4) |
|---|---|---|---|
| 1 | 20 | 0 | 80 |
| 2 | 30 | 0 | 70 |
| 3 | 40 | 0 | 60 |
| 4 | 50 | 0 | 50 |
| 5 | 50 | 0 | 50 |
| 6 | 40 | 20 | 40 |
| 7 | 40 | 20 | 40 |
| 8 | 70 | 0 | 30 |
| 9 | 50 | 20 | 30 |
| 10 | 50 | 20 | 30 |
| 11 | 50 | 20 | 30 |
| 12 | 50 | 25 | 25 |
| 13 | 60 | 20 | 20 |
| 14 | 60 | 20 | 20 |
| 15 | 60 | 20 | 20 |
| 16 | 60 | 20 | 20 |
| 17 | 50 | 0 | 50 |
| 18 | 50 | 0 | 50 |
| 19 | 50 | 0 | 50 |
| 20 | 50 | 0 | 50 |
| 21 | 50 | 0 | 50 |
| 22 | 50 | 0 | 50 |
| 23 | 50 | 0 | 50 |
| 24 | 50 | 0 | 50 |
| 25 | 50 | 0 | 50 |

(1) Amounts are in % weight of total monomer (excluding cross-linking agent)
(2) ACN = Acrylonitrile
(3) DMI = Dimethyl itaconate
(4) THFMA = Tetrahydrofurfuryl methacrylate

TABLE 2
Content of Organic Phase (1)

| | Amount | Crosslinking | Blowing Agent/ |
|---|---|---|---|
| Example | Monomer | Agent (2) | Amount (3) |
| 1 | 100 | 0.40 | iB/21 |
| 2 | 100 | 0.40 | iB/21 |
| 3 | 100 | 0.40 | iB/21 |
| 4 | 100 | 0.40 | iB/21 |
| 5 | 100 | 0.30 | iB/21 |
| 6 | 100 | 0.40 | nB/21 |
| 7 | 100 | 0.40 | iB/21 |
| 8 | 100 | 0.33 | nB/21 |
| 9 | 100 | 0.40 | nB/21 |
| 10 | 100 | 0.64 | nB/21 |
| 11 | 100 | 0.40 | iB/21 |
| 12 | 100 | 0.33 | nB/21 |
| 13 | 100 | 0.33 | nB/21 |
| 14 | 100 | 0.33 | nB/21 |
| 15 | 100 | 0.40 | nB/21 |
| 16 | 100 | 0.33 | nB/21 |
| 17 | 100 | 0.40 | iB/11 + iP/10 |
| 18 | 100 | 0.40 | iB/11 + iO/10 |
| 19 | 100 | 0.40 | iB/14.7 + iP/6.3 |
| 20 | 100 | 0.80 | iB/14.7 + iP/6.3 |
| 21 | 100 | 1.20 | iB/14.7 + iP/6.3 |
| 22 | 100 | 0.4 | iB/14.7 + iP/6.3 |
| 23 | 100 | 0.4 | iB/14.7 + iP/6.3 |
| 24 | 100 | 0.8 | iB/14.7 + iP/6.3 |
| 25 | 100 | 0.8 | iB/21 |

(1) Amounts in weight parts, in addition to 100 weight parts monomer
(2) Crosslinking agent = trimethylolpropane trimethacrylate
(3) Charged amount (in weight-%) of the organic phase, i.e. monomers, blowing agent and
crosslinker;
iB = isobutane;
nB = n-Butane;
iP = isopentane;
iO = isooctane

TABLE 3
Amount of charged silanized colloidal silica (g silica/1 organic phase)

| Example | Silica A (1) | Silica B (2) |
|---|---|---|
| 1 | 0 | 60 |
| 2 | 0 | 60 |
| 3 | 0 | 60 |
| 4 | 0 | 60 |
| 5 | 0 | 60 |
| 6 | 96 | 0 |
| 7 | 0 | 60 |
| 8 | 96 | 0 |
| 9 | 96 | 0 |
| 10 | 96 | 0 |
| 11 | 0 | 60 |
| 12 | 0 | 70 |
| 13 | 96 | 0 |
| 14 | 0 | 60 |
| 15 | 96 | 0 |
| 16 | 0 | 60 |
| 17 | 0 | 60 |
| 18 | 0 | 60 |
| 19 | 0 | 60 |
| 20 | 0 | 60 |
| 21 | 0 | 60 |
| 22 | 0 | 60 |
| 23 | 0 | 60 |
| 24 | 0 | 60 |
| 25 | 0 | 60 |

(1) Silica A = 50 wt % aqueous colloidal silica with volume average particle size of 60 nm, and which is surface modified with glycidoxypropylsilane and propylsilane in a 60:40 molar ratio, with a total surface coverage of 2.37 μmol/m² of silica surface.
(2) Silica B = 50 wt % aqueous colloidal silica with a volume average particle size of 32 nm, and which is surface modified with glycidoxypropoxysilane and propylsilane in a 50:50 molar ratio, with a total surface coverage of 2.37 μmol/m² of silica surface.

TABLE 4
Expandable Microsphere Properties

| Example | D/μm (1) | Span (2) | Volatile Content (wt %) (4) |
|---|---|---|---|
| 1 | 9.6 | 0.9 | 7.0 |
| 2 | 10.7 | 1.1 | 16.8 |
| 3 | 10.8 | 0.9 | 19.4 |
| 4 | 10.6 | 1.2 | 17.8 |
| 5 | 11.5 | 1.3 | 16.8 |
| 6 | 10.2 | 1.2 | 20.3 |
| 7 | 9.4 | 1.0 | 9.6 |
| 8 | 13.7 | 0.9 | 16.2 |
| 9 | 10.8 | 0.9 | 15.2 |
| 10 | 12.0 | 0.8 | 2.5 (3) |
| 11 | 10.2 | 1.1 | 12.6 |
| 12 | 6.3 | 1.3 | 15.4 |
| 13 | 12.5 | 0.8 | 16.7 |
| 14 | 10.6 | 1.2 | 20.3 |
| 15 | 12.5 | 0.9 | 16.0 |
| 16 | 10.4 | 1.2 | 21.7 |
| 17 | 10.4 | 1.0 | 22.5 |
| 18 | 9.9 | 0.9 | 23.9 |
| 19 | 10.5 | 1.0 | 22.5 |
| 20 | 11.1 | 0.9 | 22.4 |
| 21 | 11.9 | 1.0 | 18.4 |
| 22 | 13.5 | 1.1 | 21.4 |
| 23 | 11.4 | 1.0 | 20.3 |
| 24 | 14.0 | 1.0 | 20.6 |
| 25 | 12.5 | 0.8 | 15.8 |

(1) Volume median particle size of unexpanded microspheres
(2) [D90-D10]/D50
(3) Average of two measurements taken
(4) Volatile content of the microspheres, measured by TGA in weight-%; based on the total weight of the microspheres

TABLE 5
Expansion Characteristics

| | TMA | | | TMA | | |
|---|---|---|---|---|---|---|
| | Density | Tₛₜₐᵣₜ | Tₘₐₓ | Density | Tₛₜₐᵣₜ | Tₘₐₓ |
| | (g L⁻¹) | (° C.) | (° C.) | (g L⁻¹) | (° C.) | (° C.) |
| Example | Directly after synthesis | | | After 4 months’ storage | | |
| 1 | 371.3 | 94 | 98 | (1) | (1) | (1) |
| 2 | 39.4 | 91 | 94 | (1) | (1) | (1) |
| 3 | 35.5 | 93 | 101 | (1) | (1) | (1) |
| 4 | 30.0 | 94 | 112 | 30.1 | 94 | 111 |
| 5 | 47.9 | 94 | 113 | (1) | (1) | (1) |
| 6 | 22.5 | 96 | 127 | 92.9 | 90 | 96 |
| 7 | 229.9 | 97 | 102 | (1) | (1) | (1) |
| 8 | 22.2 | 109 | 133 | 23.6 | 108 | 123 |
| 9 | 25.0 | 108 | 122 | 33.4 | 108 | 121 |
| 10 | 150 (2) | 105 | 110 | (1) | (1) | (1) |
| 11 | 122.8 | 96 | 127 | (1) | (1) | (1) |
| 12 | 75.0 | 108 | 114 | (1) | (1) | (1) |
| 13 | 15.7 | 111 | 134 | 19.0 | 111 | 133 |
| 14 | 14.9 | 109 | 133 | (1) | (1) | (1) |
| 15 | 16.0 | 108 | 135 | (1) | (1) | (1) |
| 16 | 17.3 | 109 | 133 | 18.8 | 109 | 133 |
| 17 | 14.3 | 110 | 120 | (1) | (1) | (1) |
| 18 | 29.4 | 129 | 140 | (1) | (1) | (1) |
| 19 | 15.5 | 106 | 114 | (1) | (1) | (1) |
| 20 | 17.9 | 102 | 111 | (1) | (1) | (1) |
| 21 | 33.2 | 102 | 115 | (1) | (1) | (1) |
| 22 | 38.7 | 103 | 112 | (1) | (1) | (1) |
| 23 | 26.1 | 105 | 115 | (1) | (1) | (1) |
| 24 | 26.4 | 103 | 111 | (1) | (1) | (1) |
| 25 | 35.4 | 93 | 111 | (1) | (1) | (1) |

(1) Not measured.
(2) Average of two measurements taken

TABLE 6
Residual monomer amounts after the treatment with
sodium bisulfite or sodium persulfate (ppm)

| Example | ACN (1) | THFMA (2) | DMI (3) |
|---|---|---|---|
| 5 | 1280 | 20 | |
| 12 | 921 | 10 | 10 |
| 14 | 833 | 10 | 10 |
| 17 | 841 | 20 | |
| 19 | 789 | 20 | |
| 22 | 4450 | 11 | |
| 23 | 41 | 10 | |
| 24 | 23 | 10 | |
| 25 | 63 | 10 | |

(1) ACN = Acrylonitrile
(2) THFMA = Tetrahydrofurfuryl methacrylate
(3) DMI = Dimethyl itaconate

By way of comparison, reference can be made to the disclosures of WO2019/043235 and WO2019/101749, in particular the disclosed comparative examples.

In WO2019/043235, attempts were made to prepare microspheres from caprolactone/acrylonitrile and lactic acid/acrylonitrile copolymers (Examples 31-42, as described at page 25, line 15 to page 28, line 4). Caprolactone and lactic acid are both bio-derived monomers. These attempts were unsuccessful.

Similarly, in WO2019/101749, attempts were made to prepare microspheres from acrylonitrile/methyl acrylate/dimethyl maleate and acrylonitrile/methyl acrylate/diethylmaleate copolymers (Examples 25-30, as described at page 24, line 16 to page 26, line 5). Dimethyl maleate and diethyl maleate are bio-derived monomers. These attempts were also unsuccessful.

The results presented herein demonstrate that monomers of Formula 1 can successfully be used to produce expandable thermoplastic polymeric microspheres, and therefore can be used to improve the content of sustainably-sourced material in such microspheres. Such a result is unexpected, in view of the comparative examples mentioned above.

The results also show that the microspheres can still successfully be expanded after several months storage, showing that they have good shelf-life, and good blowing agent retention characteristics.

Moreover, the results show that a treatment of the microspheres with an agent selected from oxo acids of sulphur, salts and derivatives thereof, comprising at least one sulfur atom having a least one free electron pair and binding three oxygen atoms or comprising at least two sulfur atoms which are linked via a peroxide group reduces the amount of residual monomers in the microspheres. In particular, treatment of the microspheres with an agent selected from oxo acids of sulphur, salts and derivatives thereof, comprising at least two sulfur atoms which are linked via a peroxide group may significantly reduces the amounts of residual monomers, for instance to less than 100 ppm. The reduction of the amount of residual acrylonitrile is particularly pronounced when using such persulfate treatment.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. Thermoplastic polymeric microspheres comprising a thermoplastic polymer shell surrounding a hollow core, in which the thermoplastic polymer shell comprises a copolymer of a monomer of Formula 1: 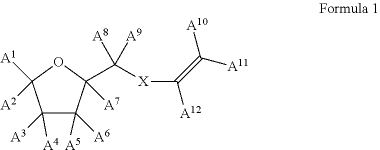
wherein:
each of A¹ to A¹¹ are independently selected from H and C₁ to C₄ alkyl, in which each C₁₋₄ alkyl group can optionally be substituted with one or more substituents selected from halogen, hydroxy and C₁₋₄ alkoxy;
A¹² is selected from C₁ to C₄ alkyl, in which the C₁₋₄ alkyl group can optionally be substituted with one or more substituents selected from halogen, hydroxy and C₁₋₄ alkoxy X is a linking group selected from —O—, —NR″—, —S—, —OC(O)—, —NR″C(O)—, —SC(O)—, —C(O)O—, —C(O)NR″—, and —C(O)S—; and
R″ is H or C₁₋₂ alkyl optionally substituted with one or more substituents selected from halogen and hydroxyl;
wherein the thermoplastic polymer shell comprises one or more other ethylenically unsaturated co-monomers not of Formula 1 having no more than one non-aromatic C═C double bond, at least one of which is a nitrile-containing monomer;
the content of nitrile-containing monomer in the copolymer being greater than about 20 wt %.

2. The thermoplastic polymeric microspheres according to claim 1, in which the one or more of the following apply to the monomer of Formula 1;
X is —OC(O)— or —NR″C(O)—;
the optional substituent on the alkyl groups of A¹ to A¹² is hydroxy;
the alkyl groups of A¹ to A¹² are unsubstituted;
any or all of A¹ to A¹¹ are selected from H and optionally substituted C₁₋₂ alkyl;
One of A¹⁰ and A¹¹ is H, and the other is H or C₁₋₂ unsubstituted alkyl;
A¹⁰ and A¹¹ are both H;
A¹² is selected from unsubstituted C₁₋₄ alkyl or unsubstituted C₁₋₂ alkyl;
A⁸ is H and A⁹ is H or unsubstituted C₁₋₂ alkyl;
A⁸ and A⁹ are both H;
any one or more of A¹ to A⁷ are selected from H and C₁₋₄ alkyl, for example C₁₋₂ alkyl, where each alkyl optionally is optionally substituted with one or more hydroxy groups;
A¹, A³, A⁵ and A⁷ are H, and A², A⁴ and A⁶ are each independently selected from H and C₁₋₂ alkyl, in which each alkyl is optionally substituted with one hydroxy group;
one of A¹ to A⁷, e.g. A¹, is monohydroxy-substituted C₁₋₂ alkyl, such as CH₂OH, and the rest are H;
no more than two of A¹ to A⁷ are unsubstituted C₁₋₂ alkyl, the rest being H;
all of A¹ to A⁷ are H;
all of A¹ to A⁹ are H;
all of A¹ to A¹¹ are H.

3. The thermoplastic polymeric microspheres of claim 2, in which the monomer is of Formula 2, Formula 3 or Formula 4; 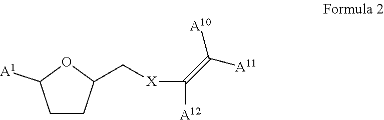 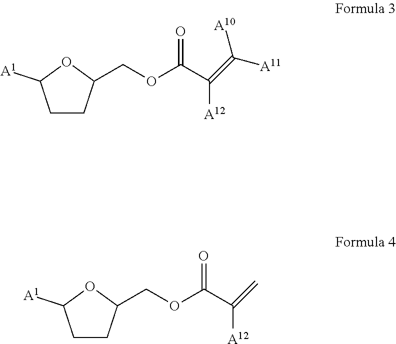
wherein optionally, in any of Formulae 2, 3 or 4, A¹ is selected from:
H or C₁₋₄ alkyl optionally substituted with hydroxy;
H, methyl or methoxy;
H or methoxy; or
H;
and/or optionally, in any of Formulae 2, 3 or 4, A¹² is selected from:
Unsubstituted C₁₋₄ alkyl; or
methyl and ethyl.

4. The thermoplastic polymeric microspheres of claim 1, in which
the content of monomer of Formula 1 in the copolymer is at least about 10 wt % and up to about 60 wt %.

5. The thermoplastic polymeric microspheres of claim 1, in which the thermoplastic polymer shell also comprises one or more crosslinking multifunctional monomer having more than one ethylenically unsaturated C═C bond.

6. The thermoplastic polymeric microspheres of any claim 1, in which one or more of the following apply;
the copolymer comprises from about 2 to about 5 different comonomers, at least one of which is of Formula 1 and at least one of which is a nitrile-containing monomer;
other ethylenically unsaturated co-monomers having a single non-aromatic C═C double bond are selected from (meth)acrylic monomers, vinyl ester monomers, styrene monomers, nitrile-containing monomers, (meth)acrylamide monomers, halogenated vinyl monomers, vinyl ethers, N-substituted maleimides, lactone monomers, and itaconate dialkylester monomers;
the co-polymer comprises less than about 10 wt % of vinyl aromatic monomer;
the content of cross-linking multifunctional monomers in the polymer shell is in the range of from about 0 to about 5 wt % of the total polymer weight.

7. The thermoplastic polymeric microspheres of claim 1, in which one or more of the following apply:
the Tₛₜₐᵣₜ is from about 50 to about 250° C.;
the Tₘₐₓ is from about 70 to about 300° C.;
the Tₘₐₓ is lower than the melting point of the polymer of the thermoplastic polymer shell.

8. The thermoplastic polymeric microspheres as claimed in claim 1, in dry form.

9. The thermoplastic polymeric microspheres as claimed in claim 1, wherein the content of nitrile-containing monomer in the copolymer is about 30 wt. % or more.

10. The thermoplastic polymeric microspheres as claimed in claim 1, wherein the residual amount of monomer is less than about 1,000 ppm.

11. The thermoplastic polymeric microspheres as claimed in claim 1, which are expandable, and where the hollow core comprises one or more blowing agents, wherein one or more of the following apply;
the blowing agent, or at least one of the blowing agents, has a boiling point (at atmospheric pressure) that is not higher than the T_{g} of the polymer constituting the thermoplastic polymer shell;
the blowing agent, or at least one of the blowing agents, has a boiling point at atmospheric pressure in the range of from about −50 to about 250° C.;
the content of blowing agent in the expandable microspheres is from about 5 to 60 about wt %;
the blowing agent, or at least one blowing agent, is selected from hydrocarbons, dialkyl ethers and halocarbons;
the blowing agent is selected from C₄₋₁₂ alkanes and dialkyl ethers where each alkyl is selected from C₂₋₅ alkyl.

12. A process for preparing thermoplastic polymeric microspheres of claim 1, in which an organic phase containing monomers and one or more blowing agents is dispersed in a continuous aqueous phase, and polymerisation is initiated by a polymerisation initiator to form an aqueous dispersion of thermoplastic polymeric microspheres comprising a thermoplastic polymer shell surrounding a hollow core, the hollow core comprising the one or more blowing agents, wherein the monomers comprise a monomer of Formula 1, and a nitrile-containing monomer in an amount of at least about 20 wt. %, based on the total monomer content.

13. The process as claimed in claim 12, in which water is removed from the aqueous dispersion to form a wet cake of microspheres or dry microspheres.

14. The process as claimed in claim 12
where the hollow core comprises one or more blowing agents, wherein one or more of the following apply:
the blowing agent, or at least one of the blowing agents, has a boiling point (at atmospheric pressure) that is not higher than the T_{g} of the polymer constituting the thermoplastic polymer shell;
the blowing agent, or at least one of the blowing agents, has a boiling point at atmospheric pressure in the range of from about −50 to about 250° C.;
the content of blowing agent in the expandable microspheres is from about 5 to 60 about wt %;
the blowing agent, or at least one blowing agent, is selected from hydrocarbons, dialkyl ethers and halocarbons;
the blowing agent is selected from C₄₋₁₂ alkanes and dialkyl ethers where each alkyl is selected from C₂₋₅ alkyl.

15. The process as claimed in claim 12, in which from about 0 to about 20 wt % of a suspending agent is used, based on the total weight of the monomer(s).

16. The process as claimed in claim 12, further comprising a step of residual monomer reduction, wherein the microspheres are treated with an agent selected from oxo acids of sulphur, salts and derivatives thereof, comprising at least one sulfur atom having a least one free electron pair and binding three oxygen atoms or comprising at least two sulfur atoms which are linked via a peroxide group.

17. A method for producing expanded thermoplastic polymeric microspheres, comprising heating expandable thermoplastic polymeric microspheres according to claim 11 such that the expandable thermoplastic polymeric microspheres expand.

18. (canceled)
